(19) United States
(12) Patent Application Publication
(10) Pub. No.: US 2006/0054684 A1
(43) Pub. Date: Mar. 16, 2006

(54) Surveillance system for application in automated teller machines

(75) Inventor: Kin Keung Dennis Li, Hong Kong (CN)

Correspondence Address: Mr. Eric Chan, 42 Pin Oaks Drive, Phoenixville, PA, 19460, US

(73) Assignee: MULTIVISION INTELLIGENT SURVEILLANCE (HONG KONG) LIMITED, Hong Kong (CN)

(21) Appl. No.: 11/222,829

(22) Filed: Sep. 12, 2005

(30) Foreign Application Priority Data
Sep. 14, 2004 (HK) 04107001.8

(51) Int. Cl. G07F 19/00; H04N 7/18

(52) U.S. Cl. 235/379; 348/150

(57) ABSTRACT

The present invention relates to a surveillance system for application in automated teller machines (ATMs) which comprises one or more automated teller machine(s), each of which is installed with hidden pin-hole video camera(s), a server and networking facilities, and a central monitoring station. The circuit board of the server has a microprocessor installed with software which automatically links the account data of an inserted ATM card with recorded video images and automatically saves temporary image backup files using the account data as parameters, as well as software which automatically compresses temporary image backup files and transmits them by long-distance real time transmission via the networking facilities to the central monitoring station for surveillance and permanent backup storage. Real time surveillance of video images or the use of parameters in backup file searches allow rapid, easy, accurate and effective monitoring of problematic transactions and retrieval of video images of a particular ATM user.

### TITLE OF THE INVENTION

A surveillance system for application in automated teller machines

### BACKGROUND OF THE INVENTION

The present invention relates to a surveillance system and more particularly pertains to a surveillance system for application in automated teller machines in the field of digital image transmission.

Banking automated teller machines (ATMs) are popular nowadays. One can withdraw cash directly from an ATM at any time with an ATM card issued by a bank. Since the only way to verify the identity of a person withdrawing cash from an ATM is by verifying the PIN number entered, an offender can easily rob an ATM customer by stealing his ATM card and its PIN number or threatening and forcing him to withdraw cash from an ATM. It has also occurred that an ATM customer first claimed that his ATM card was stolen and then used that ATM card to withdraw cash in order to swindle compensation.

In view of the aforesaid problems, most ATMs are now installed with pin-hole video cameras to record and save video images showing users'faces. When there is a report of loss of an ATM card or fraudulent transaction, the video images may be reviewed to identify and verify the face of the ATM customer, allowing easier investigation and tracking of offenders. Since conventional video cameras have to be switched on continuously for a long period of time to record images of the whole transaction period, a huge storage capacity is required and costs are high. Further, it is necessary to review a huge number of video images to retrieve the target image. Even if the target image is found, it takes time and effort to verify the associated transaction and account data. Therefore, it is usually impossible for the police to arrest offenders timely and offenders have sufficient time to continue withdrawing cash from different ATMs, spend all the stolen money, or abscond overseas.

### BRIEF SUMMARY OF THE INVENTION

In view of the aforesaid disadvantages now present in the prior art, the present invention provides a surveillance system for application in ATMs which records the transaction process and links important transaction and account data with the recorded video image of the transaction at the same time. The transaction and account data are used as parameters for searching backup files. The use of parameters in searches allows rapid, easy and accurate retrieval of problematic transactions and video images of an ATM user and allows the police to track the offender timely. Besides, the surveillance system of the present invention is a network system connecting different ATMs where each ATM in the network transmits video images to a central monitoring station in real time for surveillance. When there is a report of loss of an ATM card or fraudulent transaction, the surveillance staff can stop the offender from continuously withdrawing cash from different ATMs and immediately report to the police, allowing the police to arrest the offender and recover the stolen money as soon as possible. As the present invention keeps record of video images in a more systematic manner, recorded backup files can be compressed when necessary for future retrieval, thereby effectively reducing storage capacity requirements and costs.

To attain this, the present invention comprises one or more automated teller machine(s), each of which is installed with hidden pin-hole video camera(s), a server and networking facilities, and a central monitoring station, wherein the circuit board of the server has a microprocessor installed with software which automatically links the account data of an inserted ATM card with recorded video images and automatically saves temporary image backup files using the account data as parameters, as well as software which automatically compresses temporary image backup files and transmits them by long-distance real time transmission via the networking facilities to the central monitoring station for surveillance and permanent backup storage; the input/output terminals of the microprocessor connect to the input/output terminals of the video camera(s) and the networking facilities.

The video camera(s) and the server are switched on only when an ATM card is inserted into an ATM and recording ceases when the ATM card is withdrawn so as to reduce the recording and saving of useless images.

The account data include account number, branch number, ATM number, transaction date, transaction time and transaction amount.

The networking facilities connect to a data transmission network available in the marketplace such as Local Area Network (“LAN”), Internet, Integrated Services Digital Network (“ISDN”) and others by real time networking.

Each of the ATMs can connect to other ATMs via the central monitoring station.

The central monitoring station is provided with a monitor and surveillance staff can monitor the video images and account data linked to the images in real time through the monitor; the central monitoring station is also provided with a central processing unit which has a processor installed with software which automatically saves permanent backup files using the account data as parameters, searches the backup files using the parameters and sends signals to designated ATMs to stop designated ATM cards from functioning.

### BRIEF DESCRIPTION OF THE DRAWINGS

FIG. 1 shows the network connection of an embodiment of the present invention.

### DETAILED DESCRIPTION OF THE INVENTION

The present invention is further illustrated in the following embodiment with the accompanying drawing.

This embodiment of the present invention comprises a surveillance system for application in ATMs. Each of the ATMs 1 is installed with pin-hole video camera(s), a server and networking facilities. The circuit board of the server has a microprocessor, the input/output terminals of which connect to the input/output terminals of the video camera(s) and the networking facilities. The networking facilities connect to an ISDN in real time. When a user inserts an ATM card into the ATM 1, the video camera(s) and the server will be switched on and the video camera(s) will start recording. The microprocessor then links the account data including the account number, branch number, ATM number, transaction date, transaction time and transaction amount of the inserted ATM card with the recorded video images and automatically saves temporary image backup files using the account data as parameters. It also compresses temporary image backup files and transmits them by long-distance real time transmission via the networking facilities to the central monitoring station 2 for surveillance and permanent backup storage. When the user withdraws the ATM card, the video camera stops recording and the server stops operating. This reduces the recording, transmitting and saving of useless images.

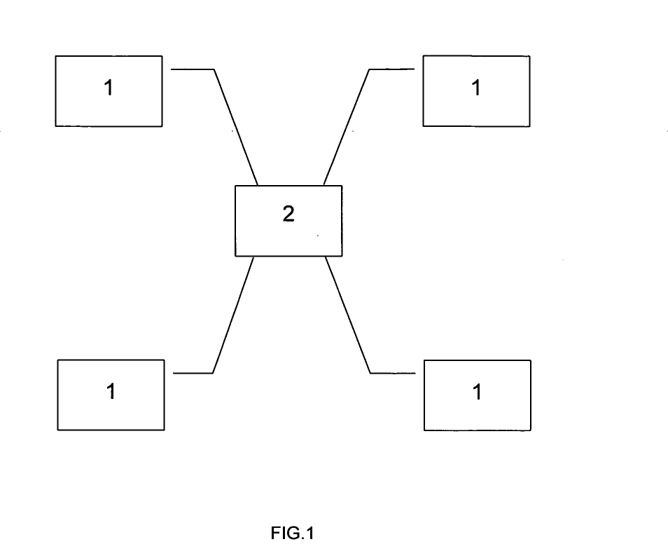

Each ATM 1 can connect to other ATMs 1 via the central monitoring station 2. FIG. 1 illustrates a network in which four ATMs 1 connect to a central monitoring station 2. The central monitoring station 2 is provided with a monitor and surveillance staff can monitor the video images and account data linked to the images in real time through the monitor; the central monitoring station 2 is also provided with a central processing unit which automatically saves permanent backup files using the account data as parameters for future retrieval and sends signals to designated ATMs 1 to stop designated ATM cards from functioning.

When an ATM user is forced to withdraw money from an ATM, the surveillance staff can immediately locate the ATM 1 and identify the face of the offender from the video images and the account data linked to the images as displayed. Reports can immediately be made to the police so that the offender may be arrested timely. When there is a report of loss of an ATM card or fraudulent transaction, the surveillance staff can search the image backup files using the parameters. For instance, to retrieve the video images and account data of transactions occurring at ATM No. 99 from 9 am to 10 am on 9th Sep. 1999, the surveillance staff may simply input the said date, time period and ATM number to the central processing unit. The relevant video images together with the account and transaction data will then be displayed on the monitor. In this way, problematic transactions and video images of an ATM user can be retrieved easily and accurately, allowing the police to investigate the case and arrest the offender timely.

What is claimed is:

1. A surveillance system for application in automated teller machines comprising: one or more automated teller machine(s), each of which is installed with hidden pin-hole video camera(s), a server and networking facilities, and a central monitoring station, wherein the circuit board of the server has a microprocessor installed with software which automatically links the account data of an inserted ATM card with recorded video images and automatically saves temporary image backup files using the account data as parameters, as well as software which automatically compresses temporary image backup files and transmits them by long-distance real time transmission via the networking facilities to the central monitoring station for surveillance and permanent backup storage; the input/output terminals of the microprocessor connect to the input/output terminals of the video camera(s) and the networking facilities.

2. The surveillance system for application in automated teller machines as in claim 1, wherein the video camera(s) and the server are switched on only when an ATM card is inserted into an ATM and recording ceases when the ATM card is withdrawn so as to reduce the recording and saving of useless images.

3. The surveillance system for application in automated teller machines as in claim 1, wherein the account data include account number, branch number, ATM number, transaction date, transaction time and transaction amount.

4. The surveillance system for application in automated teller machines as in claim 1, wherein the networking facilities connect to a data transmission network available in the marketplace such as Local Area Network (“LAN”), Internet, Integrated Services Digital Network (“ISDN”) and others by real time networking.

5. The surveillance system for application in automated teller machines as in claim 1, wherein each of the ATMs can connect to other ATMs via the central monitoring station.

6. The surveillance system for application in automated teller machines as in claim 1 or 5, wherein the central monitoring station is provided with a monitor and surveillance staff can monitor the video images and account data linked to the images in real time through the monitor; the central monitoring station is also provided with a central processing unit which has a processor installed with software which automatically saves permanent backup files using the account data as parameters, searches the backup files using the parameters and sends signals to designated ATMs to stop designated ATM cards from functioning.
